(19) United States
(12) Patent Application Publication
(10) Pub. No.: US 2017/0092077 A1
(43) Pub. Date: Mar. 30, 2017

(54) APPARATUS FOR DISCHARING HETEROGENEOUS PRODUCTS

(71) Applicant: ANDAMIRO CO., LTD., Goyang-si (KR)

(72) Inventors: Myoung Soo LIM, Seoul (KR); Soo Min PARK, Seoul (KR)

(21) Appl. No.: 14/865,171

(22) Filed: Sep. 25, 2015

(51) Int. Cl. G07F 17/32

(52) U.S. Cl. CPC G07F 17/3297

(57) ABSTRACT

Provided is an apparatus for discharging heterogeneous products. The apparatus for discharging heterogeneous products of the present invention includes a conveying unit adapted to carry inputted tokens and cards, a separation unit adapted to separate the tokens and the cards transferred from the conveying unit from each other, a token discharging port adapted to discharge the tokens separated from the separation unit, and a card discharging port adapted to discharge the cards separated by the separation unit, so that the heterogeneous products can be effectively and accurately separated and discharged.

### BACKGROUND OF THE INVENTION

Field of the Invention

The present invention generally relates to an apparatus for discharging products and, more particularly, to an apparatus for discharging heterogeneous products that can effectively separate heterogeneous products and can discharge the heterogeneous products upon dividing and discharging the heterogeneous products, such as tokens, cards, and the like, as a result of playing a game using a game machine.

Description of the Related Art

Generally, most conventional game machines are configured such that the game machine is operated by detecting a token, a coin, or the like inserted into an inlet port formed at a body of each game machine and then enabling a player to play a game using a plurality of buttons.

An example of these game machines includes a token pusher game machine capable of providing a token.

In general, the token pusher game machine is operated such that when a player inserts a token and presses a game button, the token is put on a table and may fall from the table by being pushed by a pusher performing a reciprocating motion on the table, thereby returning the token to the player according to an operation result.

Such a token pusher game machine is configured such that the token fallen from the table by the pusher performing a reciprocating motion on the table is put in a specific inlet hole and thus is returned to the player, and a token inputting guide is installed so that the token can be put on the table.

Here, the player plays a game so that the token loaded on the table drops at a desired position of the inlet hole according to movement of the pusher by adjusting an inputting direction of the token using the token inputting guide.

However, since the conventional token pusher game machine is a device discharging only the token, namely, only one kind of product, when different kinds of products such as tokens and cards are discharged, it cannot separate these products from each other to discharge them.

### CONVENTIONAL ART DOCUMENT

### Patent Document

Korean Patent No. 0942641 (Feb. 8, 2010)

### SUMMARY OF THE INVENTION

Accordingly, the present invention has been made keeping in mind the above problems occurring in the related art, and an object of the present invention is to provide an apparatus for discharging heterogeneous products, that can separate and discharge heterogeneous products in spite of a heterogeneous product, such as tokens, cards, and the like being input.

Also, another object of the present invention is to provide an apparatus for discharging heterogeneous products, which can separate the heterogeneous products including the cards and tokens without damage thereto.

Also, a further object of the present invention is to provide an apparatus for discharging heterogeneous products, which can first discharge products having a predetermined weight, such as tokens, and can then separate products having a large volume in spite of a small weight, such as cards.

Also, yet another object of the present invention is to provide an apparatus for discharging heterogeneous products, that can simultaneously drive a belt of a conveying unit and a transfer member using one motor.

Furthermore, still another object of the present invention is to provide an apparatus for discharging heterogeneous products, the apparatus being configured such that rotations in forward and reverse directions are driven by one motor to cross each other.

In order to achieve the above objects, according to one aspect of the present invention, there is provided an apparatus for discharging heterogeneous products, including a conveying unit adapted to carry the inputted heterogeneous products; a separation unit adapted to separate the heterogeneous products from each other as a first product and a second product; a first product discharging port discharging the first product separated by the separation unit; and a second product discharging port discharging the second product separated by the separation unit.

The separation unit may discharge the first product transferred from the conveying unit to a lower portion and may move the second product to be separated from the first product.

The separation unit may be formed in a bar-like shape, and the separation unit may discharge tokens to the lower portion via a groove between adjacent bars and may transfer cards for discharge.

The separation unit may be configured such that at least two separation parts are installed, and a transfer member is interposed between the separation parts, and the bars of the separation unit may be configured such that the bars of a separation part are formed to cross the bars of another separation part.

The conveying unit may include a conveyor belt connecting a conveyor driving shaft and a conveyor auxiliary shaft, the conveyor driving shaft being by a motor, and the apparatus for discharging the heterogeneous product may further include: a motor; a conveyor driving shaft connected to the motor by a shaft; a reverse rotation auxiliary shaft geared with the conveyor driving shaft; and at least one transfer member connected to the reverse rotation auxiliary shaft via a driving belt and operated by a driving gear, wherein the conveyor driving shaft of the motor is installed on the shaft of the motor.

Accordingly, according to the apparatus for discharging the heterogeneous products of the present invention, the heterogeneous products can be accurately separated and discharged.

Also, accordingly, according to the apparatus for discharging the heterogeneous products of the present invention, since the separation unit has a bar-like shape, tokens can be discharged to a lower portion and the cards can be transferred for discharge, thereby enabling the heterogeneous product to be easily separated from each other.

Also, since at least two separation parts are installed, the bars of one separation part can be formed to cross the bars of another separation part. Thus, it is more effective in accurately separating and discharging the heterogeneous product.

Furthermore, since the conveying unit and the separation unit are configured to cross each other, the apparatus for discharging the heterogeneous products may be configured to have a more compact size.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view showing a game machine for discharging cards, tokens and the like according to one embodiment of the present invention;

FIG. 2 is a view showing main elements of an apparatus for discharging heterogeneous products according to the present invention;

FIG. 3 is a detailed constitutional view showing the apparatus for discharging heterogeneous products;

FIG. 4 is a reference view illustrated for explaining a driving shaft;

FIG. 5 is a perspective view illustrating one example of a separation unit for separating cards and tokens;

FIG. 6 is a plan view showing the separation unit of FIG. 5;

FIG. 7 is a side view showing the separation unit of FIGS. 1;

FIGS. 8 to 10 are reference views illustrated for explaining a process for separating the cards and the tokens; and

FIG. 11 is a view illustrated for explaining a separation unit for separating different kinds of balls, which are heterogeneous products.

### DETAILED DESCRIPTION OF THE INVENTION

Hereinbelow, preferred embodiments of the present invention will be described in detail with reference to the accompanying drawings.

All terms or words used herein should not be interpreted as being limited merely to common and dictionary meanings but should be interpreted as having meanings and concepts which are defined within the technical scope of the present invention.

Unless the context clearly indicates otherwise, it will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof. Also, the terms “˜ part”, “˜ unit”, “module”, “apparatus” and the like mean a unit for processing at least one function or operation and may be implemented by a combination of hardware and/or software.

Terms such as a first term and a second term may be used for explaining various constitutive elements, but the constitutive elements should not be limited to these terms. These terms is used only for the purpose for distinguishing a constitutive element from other constitutive element. For example, a first constitutive element may be referred as a second constitutive element, and the second constitutive element may be also referred to as the first constitutive element.

As used herein, it should be understood that the term “and/or” includes any and all combinations of one or more of the associated listed items. For example, the meaning of “a first item, a second item and/or a third item” means any and all combinations that can be presented from two or more items of the first and second and third items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion such as “between” versus “directly between”, “adjacent” versus “directly adjacent”, etc.

One embodiment of the present invention will be hereinafter described with reference to the accompanying drawings.

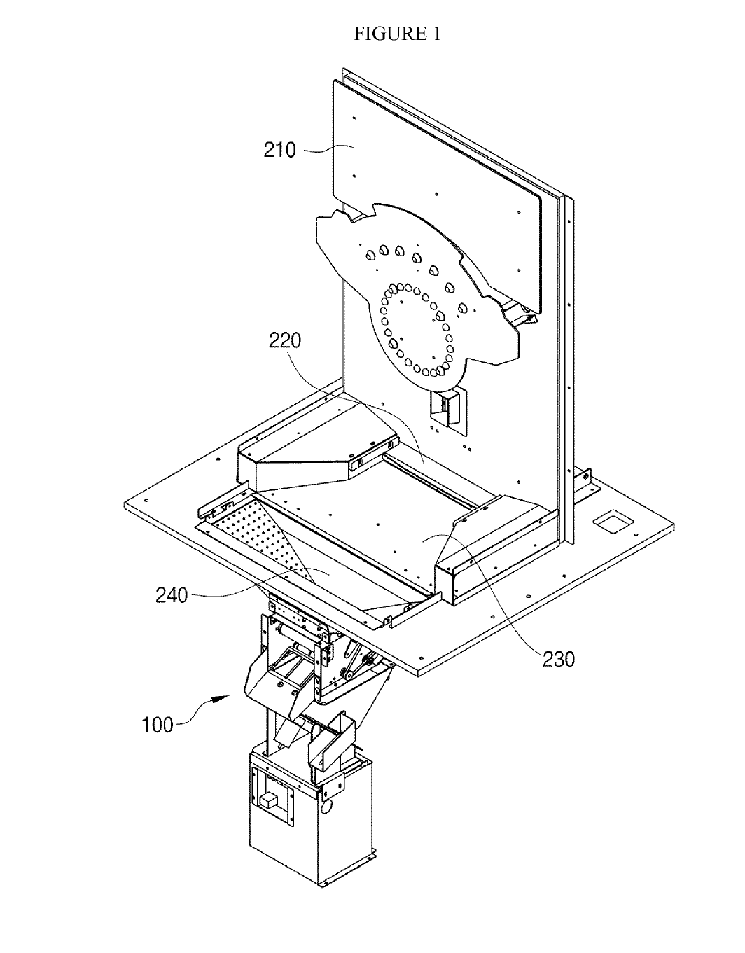

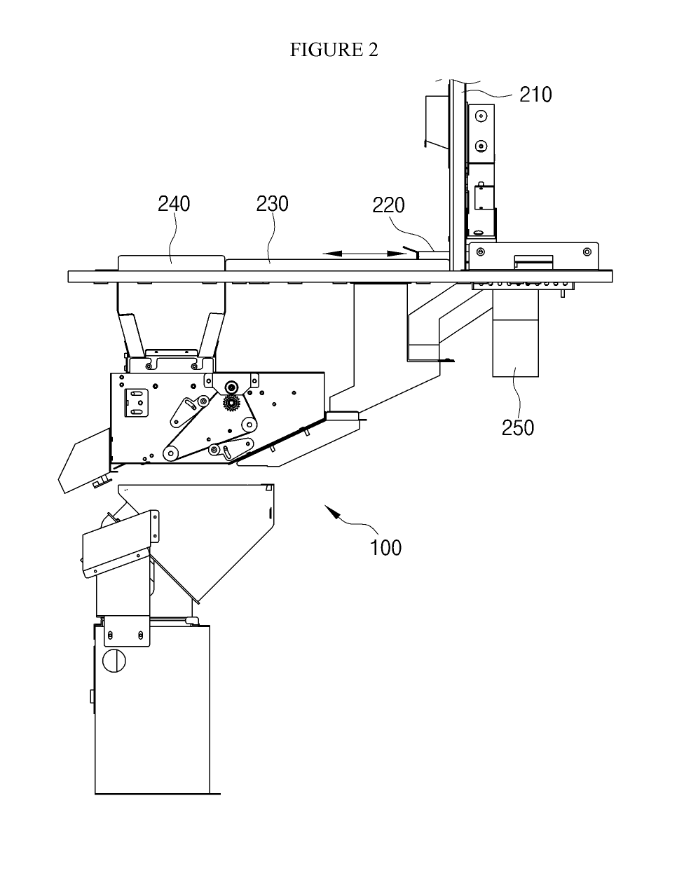

FIG. 1 is a perspective view showing a game machine for discharging cards and tokens according to an embodiment of the present invention, and FIG. 2 is a view showing main elements of an apparatus for discharging heterogeneous products according to the present invention.

As illustrated in FIG. 1, the present invention includes: a game board 210 adapted to play a predetermined game; a loading board 230 adapted to input and load heterogeneous products including tokens and cards as a result of playing the game; a pusher 220 adapted to push the heterogeneous products in a direction intended for discharging the heterogeneous products; an inlet port 240 adapted to input the cards and the tokens pushed by the pusher 220; and an apparatus for discharging the heterogeneous products 100, adapted to separate and discharge the heterogeneous products inputted to the inlet port 240.

In the following description of the present invention, even though an example in which heterogeneous products are loaded as a result of playing a game, and the loaded products are inputted to the inlet port 240 by the pusher has been described, this example is only provided for convenience of the description, and the present invention should not be limited thereto. Thus, as a result of playing a game, if heterogeneous products can be simultaneously inputted to the inlet port, this form may be also applied to the present invention.

Also, in the embodiment of the present invention, a card, which is a first product, and a token, which is a second product, have been described as exemplary heterogeneous products, but the heterogeneous products should not be limited thereto. If products have different sizes or have different weights and sizes, the products may be variously applied as the heterogeneous products according to some embodiments.

Referring to FIG. 2, when tokens and cards are loaded on the loading board 230, the pusher connected to a motor 250 performs a reciprocating motion in a direction indicated by an arrow and pushes the tokens or the cards, or both of them. When the pushed tokens or the cards, or both of them are inputted to the inlet port 240 and are then inputted to the apparatus for discharging the heterogeneous products 100, the apparatus for discharging the heterogeneous products 100 separates the inputted tokens and card from each other to discharge the tokens and the cards.

To do so, the apparatus for discharging the heterogeneous products 100 includes: a conveying unit 110 adapted to carry the tokens and the cards to a separation unit 130, the tokens and the cards being heterogeneous products inputted to the inlet port 240; the separation unit 130 adapted to separate the metal and the card transferred from the conveying unit 110; a token discharging port 170 operated by a first product discharging port adapted to discharge the tokens separated by the separation unit 130; and a card discharging port 160 operated by a second product discharging port adapted to discharge the card separated by the separation unit 130.

The conveying unit 110 is operated so that the tokens and the cards, which are heterogeneous products, are transferred to a separation unit 140 using a conveyor belt 112.

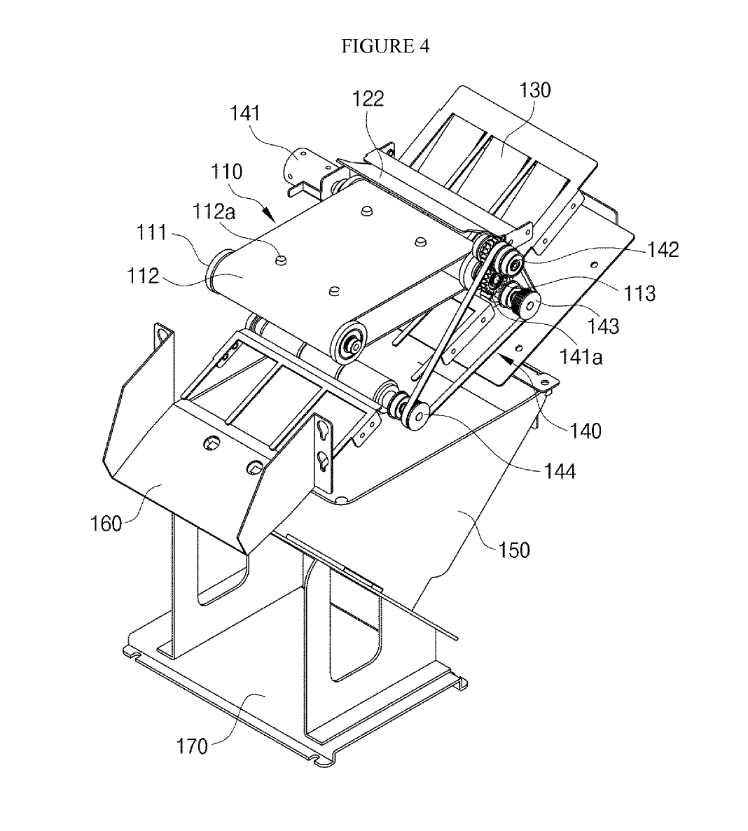

Referring to FIG. 4 illustrated for explaining a driving shaft, the conveyor belt 112 is used in a state of being inserted into a conveyor driving shaft 113 mechanically connected to a motor 141 by a shaft and operated by a driving roller, and a conveyor auxiliary shaft 111 operated by a driven roller using endless-adhesion.

The conveyor belt 112 may be composed of a cover rubber, a tension member, and an adhesive rubber layer, and a rubber belt or a PVC belt may be used as the conveyor belt. As shown in FIG. 4, the conveyor belt may have protrusions 112a made of a silicon material with excellent adhesive strength.

The conveyor driving shaft 113 is connected to the motor 141, thereby functioning to perform driving, and the conveyor auxiliary shaft 111 functions to adjust a tension of the conveyor belt 112 while having a structure in which a bearing is inserted into the conveyor auxiliary shaft.

The separation unit 130 is a device for separating and discharging the heterogeneous products transferred from the conveying unit 110 and is configured such that the tokens are discharged to a lower portion and the cards are moved so as to be separated from the token.

More specifically, the separation unit is configured such that the cards and tokens are moved to rearward of the game board via the conveyor belt 112, so that the tokens drop downwards through the combteeth of a bracket while passing through the separation parts composed of the bracket with a combteeth-like shape, and the card is discharged forward of the game board.

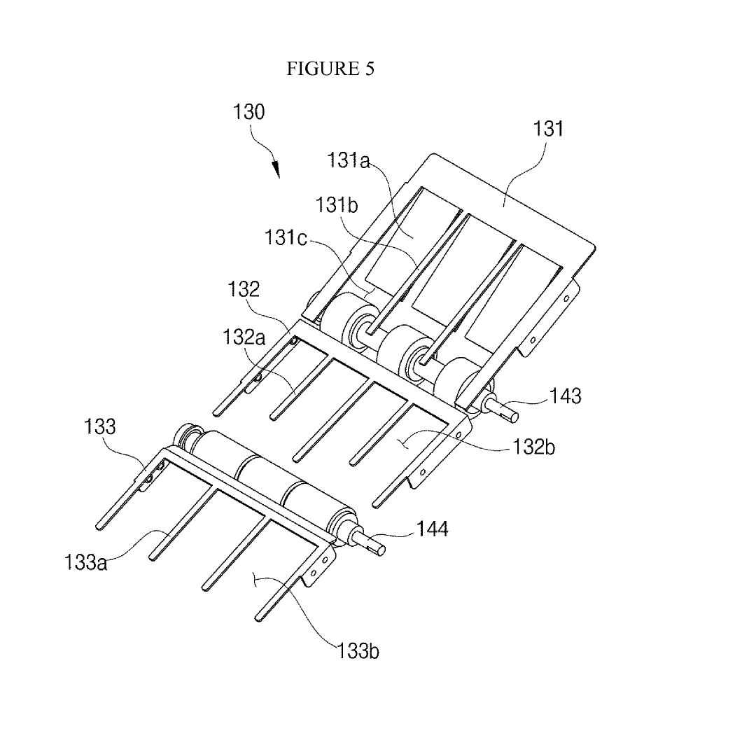

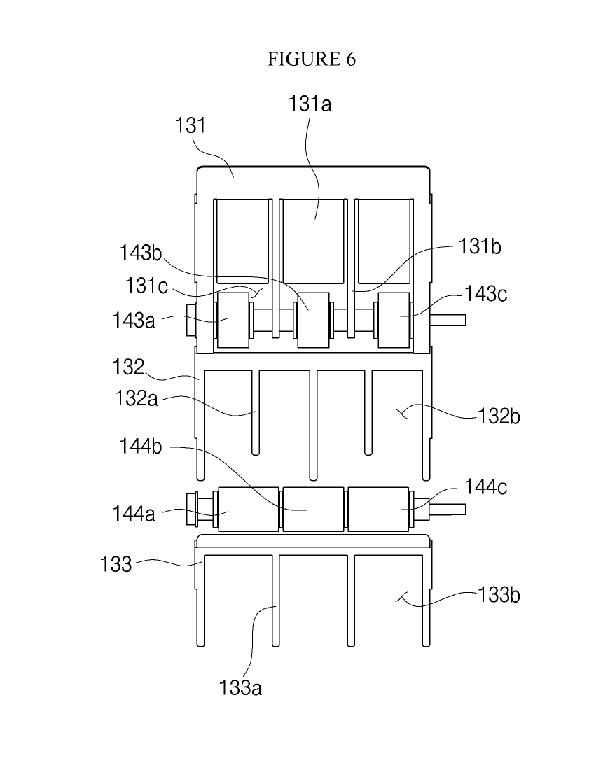

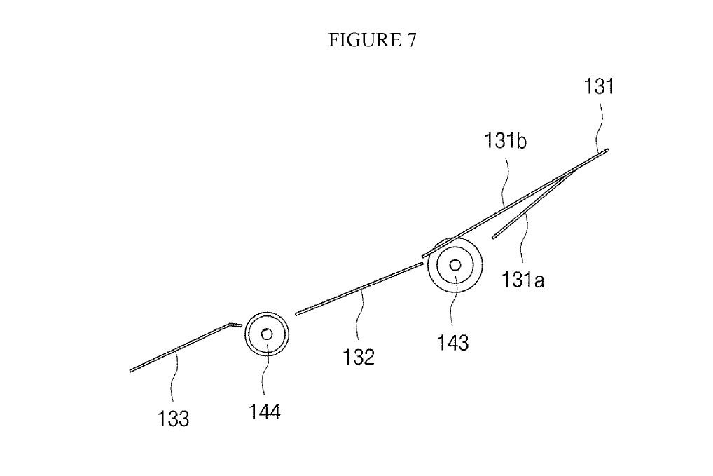

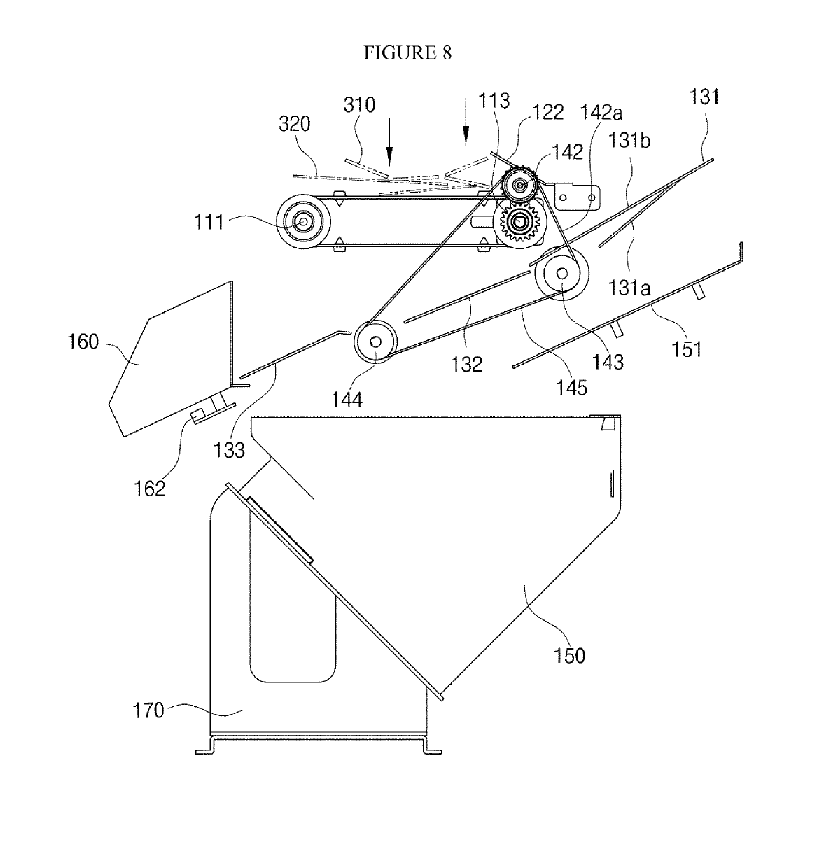

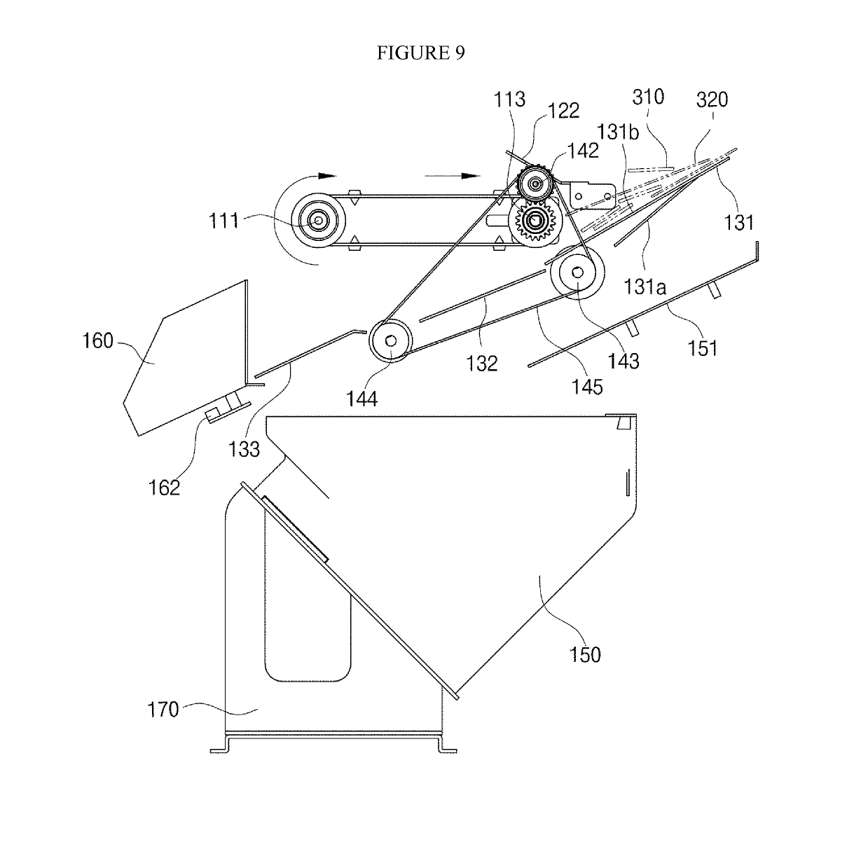

Referring to the perspective view of FIG. 5 showing an example of the separation unit of the cards and the tokens, the plane view of FIG. 6 showing the separation unit, and the side view of FIG. 7 showing the separation unit, the separation unit 130 may include: a first separation part 131; a second separation part 132; and a third separation part 133.

Referring to FIGS. 5, 6, and 7, the separation unit 130 of the present invention includes the first separation part 131 adapted to primarily discharge the tokens transferred from the conveying unit 110 to a lower portion and to move the cards to the second separation part 132 using a first transfer member 143 operated by the driving shaft for card discharging.

The first separation part 131 is formed in a bar-like shape in order to primarily discharge the tokens.

The first separation part 131 has at least one bar 131b in a movement direction of the cards, wherein a distance between the adjacent bars is formed smaller than a minimum width (a width having a shorter length in length and breadth) so that the cards cannot be discharged. Furthermore, a slide 131a is installed between the adjacent bars to be downwardly inclined in the same direction as that of the bars at a rear surface of the first separation part 131 and is installed to be spaced apart from the first transfer member 143 by a predetermined distance.

This constitution is intended to guide the tokens so that the tokens transferred to the first separation part 131 slide along the slide 131a and drop down through a dropping groove 131c formed between an end of the slide and the first transfer member 143.

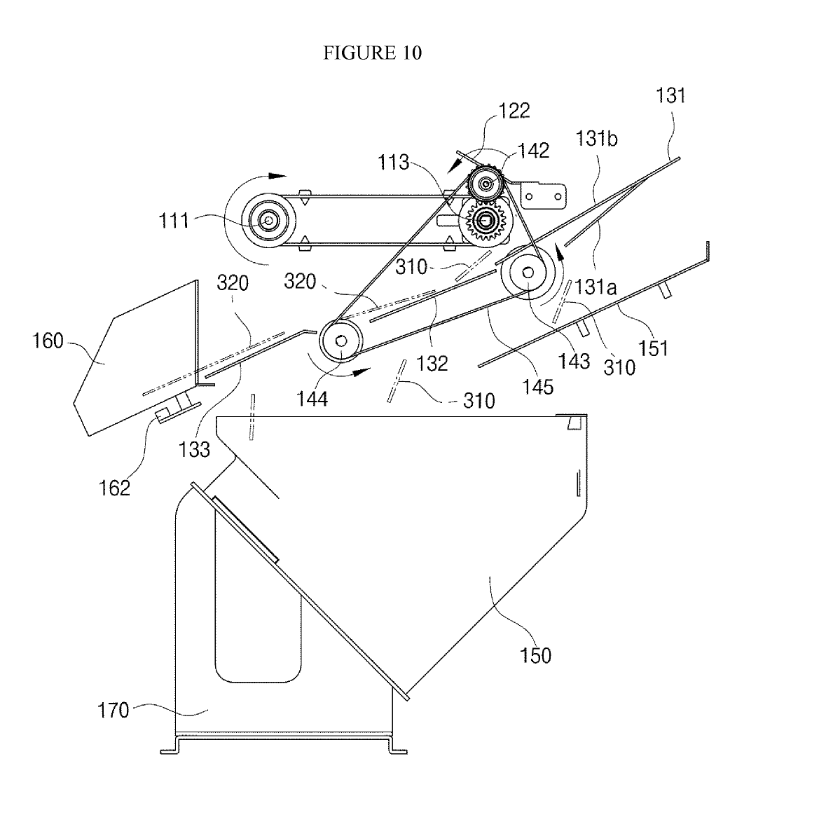

Referring to FIG. 10 illustrated for explaining a process for separating the cards and the tokens, the tokens 310 drop from the slide 131a through the dropping groove 131c, and the dropped tokens 310 are inputted to a hopper 150 by a token transfer board 151.

When the token transfer board 151 inputs the tokens 310 dropped from the separation unit 130 to the hopper 150, the hopper 150 classifies the inputted tokens and counts the number of the inputted tokens using a sensor (not drawn).

Some tokens are collected in the hopper 150 and are again inputted to a token inputting unit of the game machine, and the remaining tokens may be discharged through the token discharging port 170.

The tokens of the first separation part 131, which have not been separated from the cards by the first separation unit, are transferred to the second separation part 132 using the first transfer member 143.

At this time, the first transfer member 143 is rotated by the motor and is composed of a roller so that each card 320 and token 310 between the adjacent bars 131b can be easily transferred to the second separation part 132, wherein a surface of the roller is made of a rubber material so that the cards and tokens are transferred without deviating from a path.

More preferably, an adhesive material may be coated on the surface of the roller so that the slid cards and tokens can be easily transferred.

Meanwhile, since the cards should be transferred from the first separation part 131 to the conveying unit 110 in a state of being normally laid (hereinafter referred to ‘an erected state’), an erecting member for erecting the cards fallen from the conveying unit 110 may be further included.

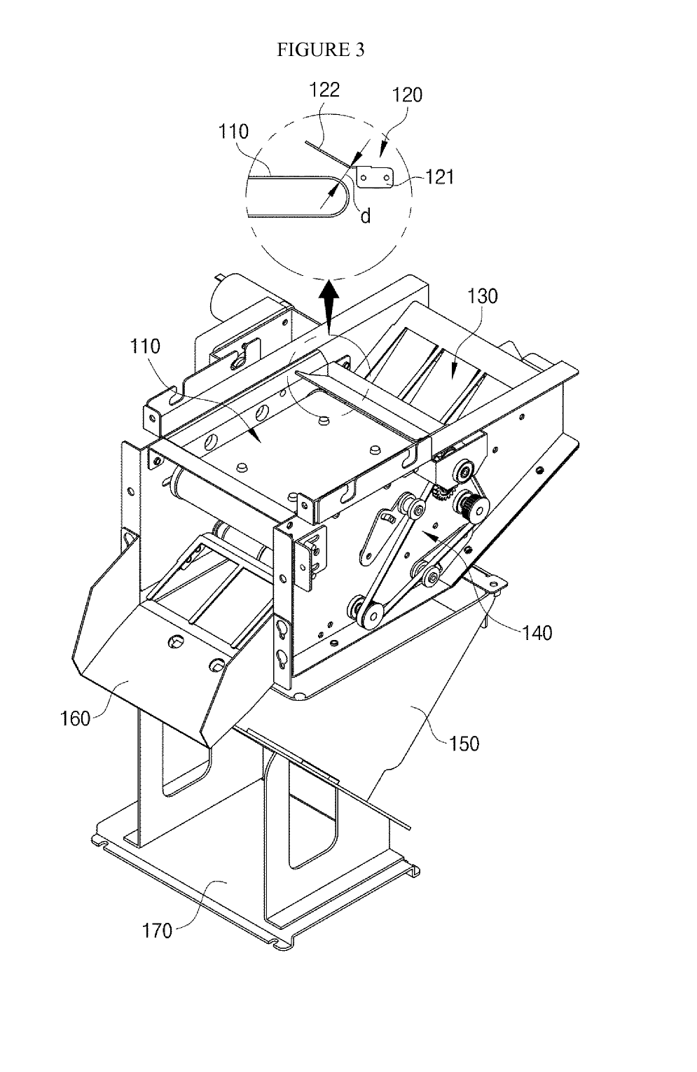

Referring to FIG. 3, a card erecting member 120 is interposed between the conveying unit 110 and the separation unit 130, thereby serving as a member for erecting the cards when the cards have unwillingly slantly fallen from the conveying unit 110.

The card erecting member 120 includes: a fixed bracket 121 fixed to any portion of the apparatus for discharging the heterogeneous products 100; an inclined plate 122 installed to be upwardly inclined at one end of the fixed bracket 121, the fixed bracket 121 being fixedly installed between the conveying unit 110 and the separation unit 130.

Thus, the card slantly fallen from the inlet port 240 is transferred by the conveying unit 110 and is then erected by an inclination of the inclined plate 122 at a position where the card is inputted to the separation unit 130.

In addition, since the card erecting member 120 is spaced apart from an end of the conveying unit 110 by a predetermined distance d, the card drops in a state of being gradually inclined as the card passes through a lower portion of the card erecting member 120. Thus, even if the token inputted to the inlet port 240 has fallen on the card, the token drops from the separation unit 130 prior to the card because the card passing through the card erecting member 120 drops in a state of being gradually inclined.

When some tokens are primarily separated from the cards by the first separation part 131, the remaining tokens and the cards are transferred to the second separation part 132.

Like the first separation part 131, the second separation part 132 inputs the tokens to the hopper 150 by forming at least one bar 132a to be smaller than a minimum width of the cards and dropping the tokens through a gap between the adjacent bars.

In order to more accurately drop the tokens, unlike in the first separation part 131, in the second separation part, the slide 131a is not formed between the adjacent bars, and only the bars are formed so that the tokens can directly drop through the dropping groove 132 between the adjacent bars.

Also, the bars 132a are installed on a rear surface of the second separation part 132 to be downwardly inclined so that the tokens or the cards transferred by the first transfer member 143 are moved while sliding, and an end of each bar is installed to be spaced apart from the second transfer member 144 by a predetermined distance.

The second transfer member 144 is rotated by the motor 141 and is composed of a roller so that some tokens and the cards, which have not been separated by the second separation part 132, and each card 320 and token 310 between the adjacent bars 133a can be easily transferred, wherein a surface of the roller is made of a rubber material so that the cards and tokens are transferred without deviating from a path.

It is preferable that an adhesive material be coated on the surface of the roller so that the slid cards and tokens can be easily transferred.

Like the second separation part 132, the third separation part 133 also has at least one bar 133a that is configured such that the bars are inclined to be spaced apart from each other by a distance formed smaller than a minimum width of the cards so that the cards can slide. Furthermore, the tokens are inputted to the hopper 150 by dropping through a dropping groove 133b formed between the adjacent bars, and the transferred cards are discharged to the card discharging port 160.

The bars of the separation unit should be installed to cross each other so that the tokens can be more effectively discharged.

Referring to FIG. 5, the bar 132a of the second separation part 132 is positioned at a gap between the adjacent bars 131b of the first separation part 131, and the bar 133a of the third separation part 133 is positioned at a gap between the adjacent bars 132a of the second separation part 131,

The card discharging port 160 may be configured to be inclined so that the cards can be discharged to slide from each end of the bars of the third separation part 133.

Meanwhile, the card discharging port 160 has a sensor 162 that can count the number of discharged cards so that the number of supplied cards can be confirmed.

As described above, the apparatus for discharging the heterogeneous products according to the present invention is operated in such a manner that the cards and the tokens fallen on the conveying unit 110 are separated and discharged by passing through the separation unit 130.

Accordingly, it is preferable that the first transfer member 143 be installed to be spaced apart from the second transfer member 144 at an upwardly inclined angle, and the second separation part 132 be installed to be upwardly inclined with respect to the second transfer member 144.

Also, in the present invention, one motor may be used to drive the conveyor driving shaft 113 and to drive the first transfer member 143 and the second transfer member 144.

That is, the conveyor driving shaft 113 connected to the motor 141 by a shaft and operated by a driving gear, the reverse rotation auxiliary shaft 142 geared with the conveyor driving shaft 113, and at least one transfer member 143, 144 connected to the reverse rotation auxiliary shaft 142 using the driving belt 142 may be included. Thus, when the motor is rotated, the conveyor driving shaft 113 is rotated in a rotational direction of the motor, and the reverse rotation auxiliary shaft 142 is rotated in a direction opposite to the rotational direction. Furthermore, due to the driving belt rotated according to the rotation, the transfer members 143, 144 may be rotated in the same direction as the rotational direction of the reverse rotation auxiliary shaft 142. As a result, the transfer members are rotated in a direction opposite to a rotational direction of the conveying unit so that the cards and tokens can be easily carried even in a small space.

Referring to FIG. 10, as one example, when the conveyor driving shaft 113 is rotated in a clockwise direction (a direction indicated by an arrow), the reverse rotation auxiliary shaft 142 is rotated in a counterclockwise direction. Accordingly, the transfer members 143, 144 are rotated in a counterclockwise direction.

As the reverse rotation auxiliary shaft is simply used, the cards and the tokens can be easily carried and separated even in a small space of a compact size.

That is, the conveying unit 110 is installed on at a top so that the conveyor is moved rearward of the game machine. Furthermore, since the token or the card, or both of them fallen from the conveying unit can be moved to the front of the game machine, the separation unit may be disposed at a bottom of the conveying unit.

In the following description, the operations and effects of the apparatus for discharging the heterogeneous products having the constitution described above will be described.

According to an embodiment of the present invention, when the game board 210 is operated by the user, and thus the tokens and the cards are loaded on the loading board 230, the tokens or the cards, or both of them are inputted to the inlet port 240 by the pusher 220 that periodically performs a reciprocating motion.

At this time, the user may adjust an amount of the tokens or the cards, or both of them through the reciprocating motion of the pusher 220 so that the tokens or the cards, or both of them fallen from the token or card discharging port (not drawn) can be inputted in a large amount to the inlet port 240.

The tokens or the cards, or both of them inputted to the inlet port 240 fall to the conveying unit 110, and the tokens or the cards, or both of them fallen to the conveying unit 110 are erected by the card erecting unit 120 so as to be inputted to the separation unit 130 for separating and discharging the cards and the tokens.

First, the tokens fallen to the first separation part 131 primarily slide along the slide 131a, and the slid tokens fall to the dropping groove 131c and are inputted to the hopper 150, or the tokens directly fallen to the dropping groove 131c are inputted to the hopper 150 so that the tokens and the cards are primarily separated from each other.

Meanwhile, due to a width of the bar 131b, the cards are transferred to the first transfer member while sliding without falling to the dropping groove 131c.

At this time, the tokens fallen on the cards may be transferred together with the cards.

The first transfer member 143 rotated by the motor 141 transfers the remaining tokens and cards to the second separation part 132, and the second separation part enables the tokens among the tokens or the cards, or both of them transferred to the second separation part 132 to fall through the dropping groove 132b. Then, the remaining tokens and cards are again transferred to the third separation part 133 through the second transfer member 144, the remaining tokens falling to the hopper 150, and the remaining card being discharged through the card discharging port 160.

In the aforesaid embodiment of the present invention, it is shown that the first to third separation parts are formed so that tokens and cards having different volumes and weights can be more accurately separated and discharged. However, the present invention should not be limited thereto, and only the first separation part may be used, or fourth and fifth separation parts may be additionally formed. Furthermore, by installing at least one separation part to be inclined using an inclination angle without using the transfer member interposed between the adjacent separation parts, the same effects may be generated.

Also, in the present invention, based on the tokens and cards described as exemplary heterogeneous products, the method for separating the heterogeneous products with different volumes and weights has been described, but the present invention should not be limited thereto. As another heterogeneous product, different kinds of balls may be also applied to the present invention.

That is, the inputted tokens and cards are carried by the conveying unit and are separated from each other, and the balls are separated and discharged in a direction opposite to a movement direction of the conveying unit.

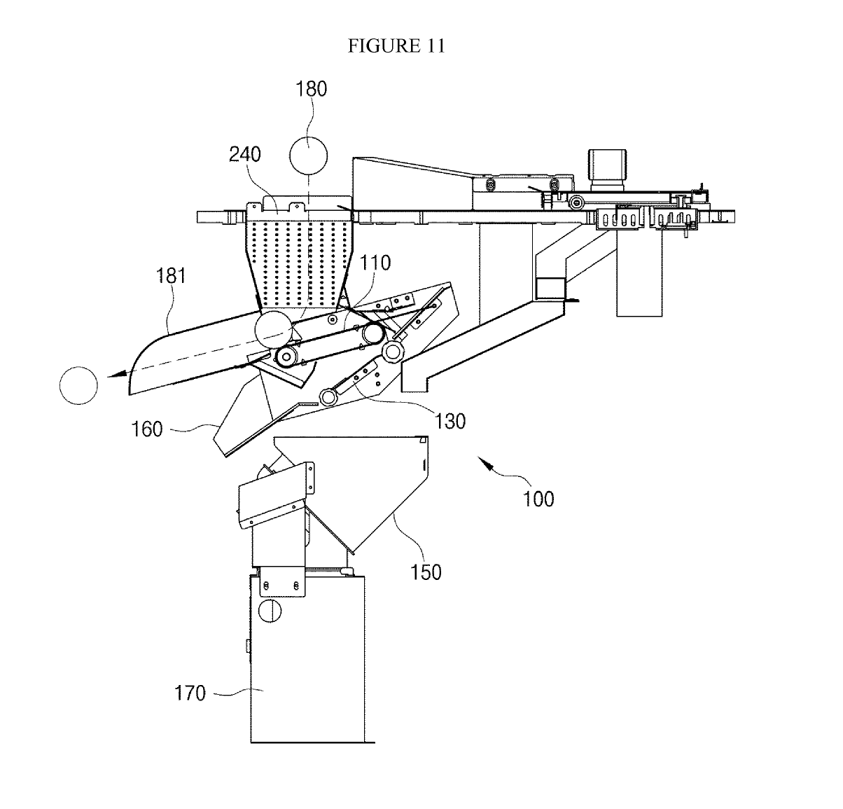

For example, as shown in FIG. 11 illustrated for explaining a separation unit for separating balls, which are heterogeneous products, even when the balls 180 other than the tokens 310 and the cards 320 are inputted, the conveying unit 110 is installed to be upwardly inclined in a rotational direction of the conveyor belt, namely, a movement direction of the tokens and the cards, and the tokens 310 and the cards 320 are moved by the conveyor belt, and the balls 180 are inputted to the conveying unit 110, and at the same time, roll in a direction opposite to an inclination direction due to inclination of the conveying unit 110 and is then discharged through a ball discharging port 181.

As described above, three kinds of heterogeneous products can be easily separated and discharged by a simple structural change.

Furthermore, as described above, one kind of product can be discharged in a front direction at the same time with inputting it to the inlet port, and the remaining heterogeneous products can be moved and discharged in a rear direction.

Although a preferred embodiment of the present invention has been described for illustrative purposes, those skilled in the art will appreciate that various modifications, additions and substitutions are possible, without deviating from the scope and spirit of the invention as disclosed in the accompanying claims.

What is claimed is:

1. An apparatus for discharging heterogeneous products, which is intended to separate and discharge the heterogeneous products including a first product and a second product with a size different from a size of the first product, the apparatus comprising:
a conveying unit adapted to carry the inputted heterogeneous products;
a separation unit adapted to separate the heterogeneous products from each other as a first product and a second product;
a first product discharging port discharging the first product separated by the separation unit; and
a second product discharging port discharging the second product separated by the separation unit.

2. The apparatus of claim 1, wherein the separation unit discharges the first product transferred from the conveying unit to a lower portion and moves the second product to be separated from the first product.

3. The apparatus of claim 2, wherein the separation unit is formed in a bar-like shape.

4. The apparatus of claim 3, wherein the separation unit discharges tokens to the lower portion via a groove between bars, and transfers cards for discharge.

5. The apparatus of claim 4, wherein the separation unit is configured such that at least two separation parts are installed, and a transfer member is interposed between the separation parts.

6. The apparatus of claim 5, wherein the bars of the separation unit are configured such that the bars of a separation part are formed to cross the bars of another separation part.

7. The apparatus of claim 6, further comprising:
a first separation part adapted to primarily separate the heterogeneous products transferred from the conveying unit from each other as the first product and the second product;
a first transfer member adapted to transfer remaining heterogeneous products of the first separation unit;
a second separation part adapted to secondarily separate the heterogeneous products transferred to the first transfer member; and
a second transfer member adapted to transfer remaining heterogeneous products of the second separation unit.

8. The apparatus of claim 7, wherein the first transfer member is installed to be spaced apart from the second transfer member at an inclination angle, the first separation unit is installed to be inclined with respect to the first transfer member, and the second separation unit is installed to be inclined with respect to the second transfer member.

9. The apparatus of claim 1, wherein the conveying unit includes a conveyor belt connecting a conveyor driving shaft and a conveyor auxiliary shaft, the conveyor driving shaft being driven by a motor.

10. The apparatus of claim 9, further comprising:
a motor;
a conveyor driving shaft connected to the motor by a shaft;
a reverse rotation auxiliary shaft geared with the conveyor driving shaft; and
at least one transfer member connected to the reverse rotation auxiliary shaft via a driving belt and operated by a driving gear,
wherein the conveyor driving shaft of the motor is installed on the shaft of the motor.

11. The apparatus of claim 10, wherein the separation unit has the transfer member transferring the first product or the second product, or both of them, and the transfer member includes the reverse rotation auxiliary shaft, the driving belt, and an adhesive material coated on a surface of the transfer member.

12. The apparatus of claim 1, wherein the first product discharging port is installed at a lower portion of the separation unit and has a sensor measuring the number of the first products inputted.

13. The apparatus of claim 1, wherein the second product discharging port is installed at one end of the separation unit and has a sensor measuring the number of the second products inputted.

14. An apparatus for discharging heterogeneous products, which is intended to separate and discharge the heterogeneous products including a first product and at least one second product having a different size from a size of the first product, the apparatus comprising:
a conveying unit adapted to carry the inputted second product and to move the first product in a direction opposite to a movement direction of the second product;
a separation unit adapted to separate the second product transferred from the conveying unit;
a first product discharging port discharging the first product moved by the conveying unit; and
a second product discharging port discharging the second product separated by the separation unit.

15. The apparatus of claim 14, wherein the conveying unit is installed to be inclined upwards with respect to a carrying direction of the second product.
